(19) United States
(12) Patent Application Publication
(10) Pub. No.: US 2004/0056818 A1
(43) Pub. Date: Mar. 25, 2004

(54) Dual polarised antenna

(76) Inventor: Victor Aleksandrovich Sledkov, Wellington (NZ)

Correspondence Address: Welsh & Katz, Ltd., Eric D. Cohen, 22nd Floor, 120 South Riverside Plaza, Chicago, IL, 60606, US

(21) Appl. No.: 10/254,211

(22) Filed: Sep. 25, 2002

(51) Int. Cl. H01Q 21/26

(52) U.S. Cl. 343/797; 343/700 MS

(57) ABSTRACT

A dual polarised antenna including two or more modules arranged along an antenna axis. Each module includes a radiating element, and four conductive walls which together form a frame around the radiating element. Each wall includes a distal edge and a pair of side edges. The side edges of the walls meet, but do not touch, at respective comers of the frame. Conductive wall assemblies are arranged between a pair of radiating elements. Each wall assembly is substantially U-shaped as viewed in a cross-section taken along the antenna axis. Each radiating patch element has first and second opposite side edges which run substantially parallel with the antenna axis. An axial isolating element is arranged between each pair of radiating patch elements and includes an elongate conductive member arranged with its length substantially parallel with the antenna axis. A transverse isolating element is arranged between each pair of radiating patch elements and includes an elongate conductive member arranged with its length substantially transverse with the antenna axis. The axial and transverse isolating elements do not touch each other. Each side wall has a projection extending from an upper edge of the side wall. The projections are positioned opposite to a centre of a respective radiating element, and each projection lies in the plane of its respective side wall. The ground plane and conductive walls are formed from a single sheet of conductive material.

### FIELD OF THE INVENTION

The present invention relates to a dual polarised antenna.

### DESCRIPTION OF RELATED ART

U.S. Pat. No. 6,023,244 describes a microstrip antenna with a metal frame arranged on the ground plane in order to control the size and direction of the antenna lobe. The walls forming the metal frame are electrically interconnected at least along one edge, which forms a line along the metal frame.

U.S. Pat No. 6,028,563 describes a dual polarised antenna with an isolation device. Various types of isolation device are described, including an isolation tree or bar, isolation rails, thin isolation rods or wires, or an isolation strip.

WO98/36472 describes a dual polarised antenna with sidewalls in various alternative configurations.

WO02/50953 describes a dual polarised antenna including a pair of side walls running along the length of the antenna, and isolation devices (either rods or walls) between the antenna elements. Rectangular tabs project inwardly towards the antenna elements from the top edges of the side walls.

U.S. Pat. No. 6,072,439 describes a dual polarised antenna with a pair of C-shaped side walls, which are fastened to a backplane by screws.

It is an object of the invention to overcome deficiencies of the prior art.

### BRIEF DESCRIPTION OF PREFERRED EMBODIMENTS

The preferred embodiments provide a dual polarised antenna including two or more modules arranged along an antenna axis, each module including a radiating element, and four conductive walls which together form a frame around the radiating element, each wall including a distal edge and a pair of side edges, wherein the side edges of the walls meet, but do not touch, at respective comers of the frame.

In order to minimize intermodulation problems, it is important that there is either complete contact between the edges of the walls, or no contact. It has been recognized that repeatable performance and simple construction results from providing no contact between the edges of the walls.

Typically at least part of the pair of side edges of each wall taper inwardly towards a respective distal edge. In one embodiment the walls taper along their entire length: in another the walls are parallel in a proximal portion of the walls, and taper in a distal portion.

Typically the walls each have a proximal base, which together form an outer border, wherein the distal edges of the walls together form an inner border, and wherein the area within the inner border is smaller than the area within the outer border.

The side edges of the walls may be separated at the corners of the frame by respective air gaps, or insulating fillers may be provided.

The radiating element may be a patch element, or any other element such as a dipole.

The preferred embodiments also provide a dual polarised antenna including two or more radiating elements arranged along an antenna axis; a plurality of conductive side walls running substantially parallel with the antenna axis; and one or more conductive wall assemblies, each wall assembly being arranged between a pair of radiating elements, wherein the or each wall assembly is substantially U-shaped as viewed in a cross-section taken along the antenna axis.

The U-shaped wall assembly can be easily installed on an antenna tray by coupling the base of the “U” to the antenna tray, for instance by way of attachment pins.

The preferred embodiments also provide a dual polarised patch antenna including two or more radiating patch elements arranged along an antenna axis, each radiating patch element having first and second opposite side edges which run substantially parallel with the antenna axis; a plurality of conductive side walls running substantially parallel with the antenna axis; and one or more conductive isolating elements, each isolating element being arranged between a pair of radiating patch elements.

The isolating element(s) may be in any form, such as a conductive wall running substantially transverse to the antenna axis, an axial strip and/or a transverse strip.

A dual polarised antenna including two or more radiating patch elements arranged along an antenna axis; one or more axial isolating elements, each axial isolating element being arranged between a pair of radiating patch elements and including an elongate conductive member arranged with its length substantially parallel with the antenna axis; and one or more transverse isolating elements, each transverse isolating element being arranged between a pair of radiating patch elements and including an elongate conductive member arranged with its length substantially transverse with the antenna axis, wherein the axial and transverse isolating elements do not touch each other.

The preferred embodiments also provide a dual polarised antenna including two or more radiating elements arranged along an antenna axis; and a plurality of planar conductive side walls running substantially parallel with the antenna axis, wherein each side wall has a projection extending from an upper edge of the side wall, each projection being positioned opposite to a centre of a respective radiating element, and wherein each projection lies in the plane of its respective side wall.

The preferred embodiments also provide a dual polarised antenna including a radiating element; a ground plane; and a pair of conductive walls arranged on opposite sides of the radiating element, each wall subtending an acute angle with the ground plane, wherein the ground plane and conductive walls are formed from a single sheet of conductive material.

### BRIEF DESCRIPTION OF THE DRAWINGS

The accompanying drawings, which are incorporated in and constitute part of the specification, illustrate embodiments of the invention and, together with the general description of the invention given below, serve to explain the principles of the invention.

FIGS. 1a and 1b together show an exploded isometric view of a panel antenna;

FIG. 2 is a side view of the antenna;

FIG. 3 is a plan view of the antenna;

FIG. 4 is an enlarged side view of the part of the antenna encircled in FIG. 2;

FIG. 5a is a top view of a PCB;

FIG. 5b is a underside view of a PCB;

FIG. 6 is a perspective view of an alternative panel antenna;

FIG. 7 is a plan view of the antenna of FIG. 6; and

FIG. 8 is a side view of the antenna of FIG. 6.

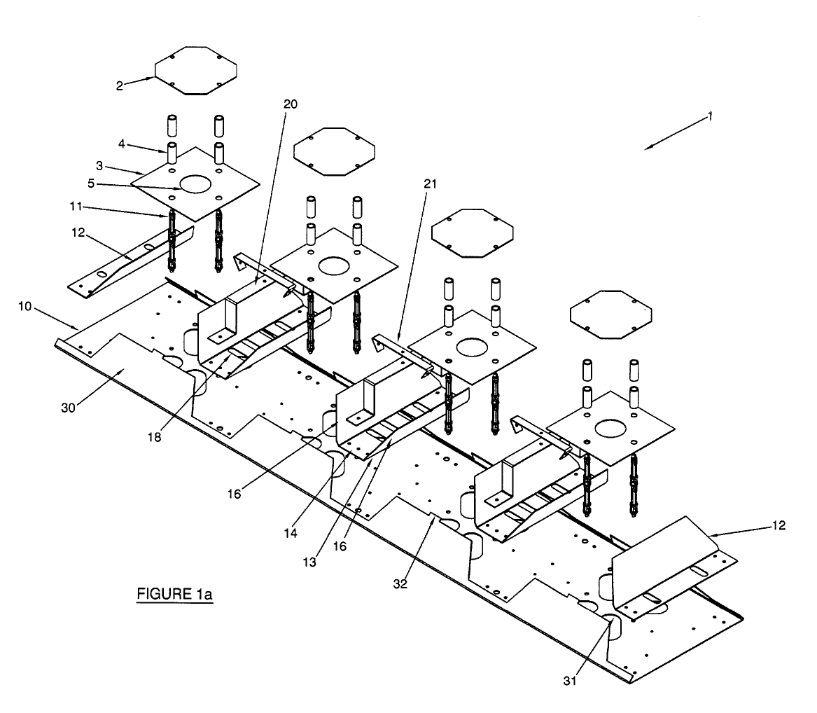

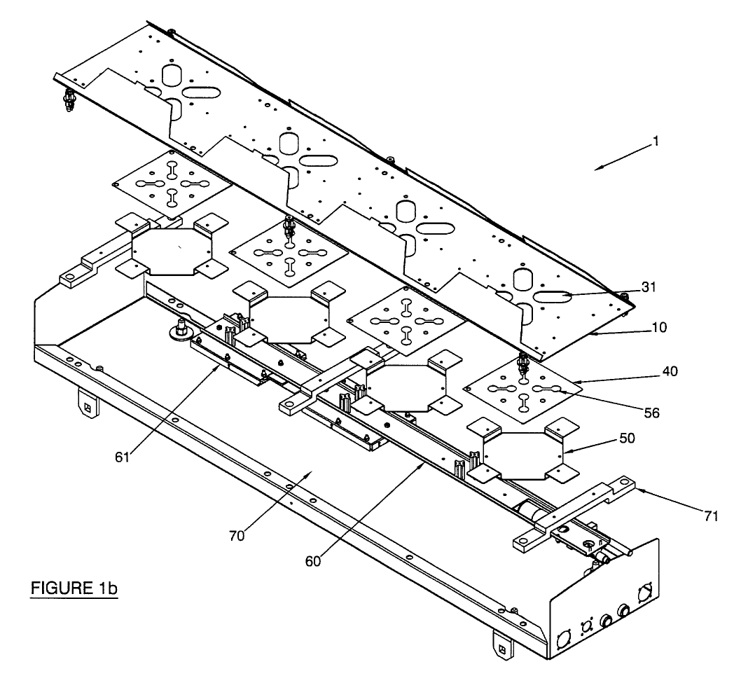

A panel antenna 1 (dual slant, ±45° polarisation) is shown in FIGS. 1 to 3. Certain elements of the finished article (for instance the radome) are omitted from the figures for clarity. In addition, the antenna is shown in FIGS. 1a and 1b in a horizontal orientation, although in use the antenna is generally oriented vertically with the patches directed outwardly. The terms “upper”, “lower” etc will be used with reference to the orientation of FIG. 1. FIG. 1a shows the upper items of the antenna in exploded isometric form, and FIG. 1b shows the remaining lower items of the antenna in exploded isometric form. Patch tray 10 is shown in both FIGS. 1a and 1b to provide a link between the two figures.

Four upper patch elements 2 are mounted on lower patch elements 3 by insulating spacers 4. The upper patch elements 2 are formed from square sheets with cut-off corners to provide the eight-sided shape shown. The lower patch elements 3 are provided with circular central apertures 5, and are mounted on patch tray 10 via insulating spacers 11. The base of the patch tray 10 acts as a ground plane.

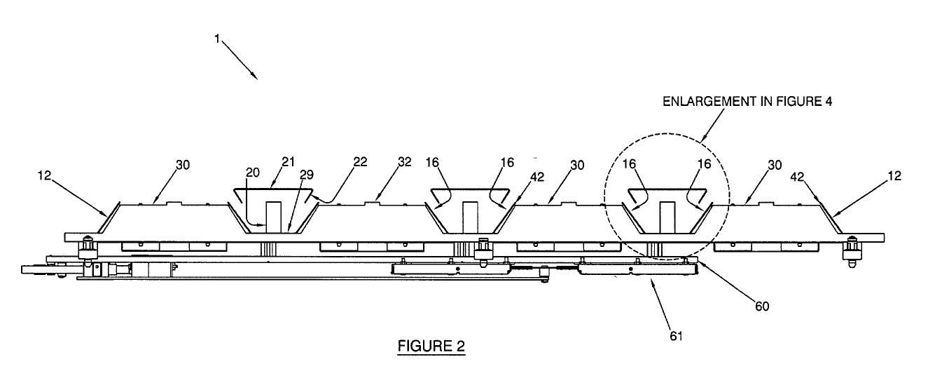

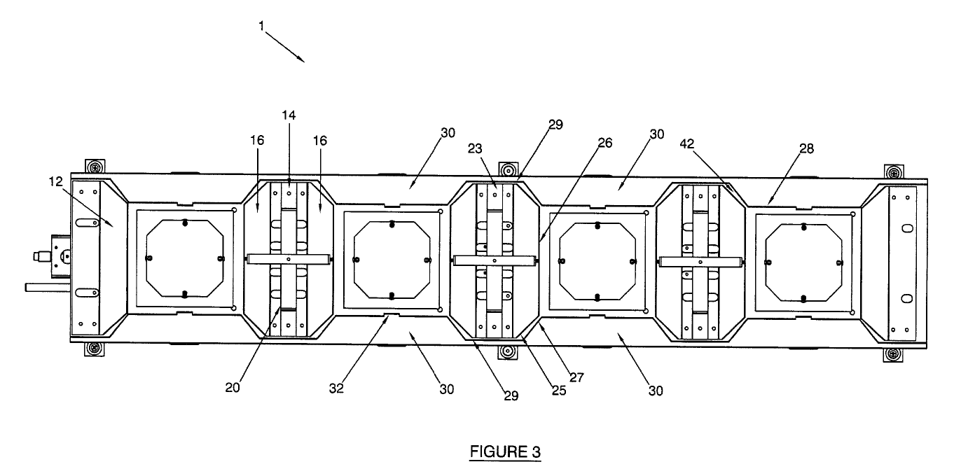

A pair of end walls 12 are mounted at opposite ends of the patch tray 10, and three double wall assemblies 13 are provided, each positioned between a respective pair of patch assemblies. The double wall assemblies 13 are generally U-shaped in cross-section and have a base 14, and a pair of outwardly angled walls 16 which lie transverse to the antenna axis. The walls 12,16 have angled side edges (one of which is labelled 25 in FIGS. 3 and 4) and taper from a relatively broad base to a relatively narrow distal upper edge 26.

The patch tray 10 is formed from a single planar sheet of aluminium, which is folded at the edge to form side walls 30 with tabs 32. Four sets of apertures 31 are punched out of the base of the patch tray 10, aligned with each patch assembly. Off-cuts are provided between the side walls 30 so as to provide angled side edges (one of which is labelled 27 in FIGS. 3 and 4). Thus the side walls 30 taper from a relatively broad base to a relatively narrow distal upper edge 28. The rectangular tabs 32 project from the upper edges 28 and lie in the same plane as the side walls 30.

Thus the side walls 30 and transverse walls 12,16 substantially enclose the patch assemblies in a tapered box-like frame, as shown most clearly in the plan view of FIG. 3. However, the walls do not completely enclose the patch assemblies. In particular, the side edges 25,27 of the walls at the corner of the square frame do not touch. The air gap 42 between the edges 25,27 tapers slightly as shown in FIGS. 3 and 4. Alternatively the edges 25,27 may be parallel. However, it is important that there is no contact between the edges 25,27. Insulating spacers may be mounted in the air gap 42 if desired, although preferably the air gap 42 is left open.

The sheet is not completely cut-away between the side walls 30. Instead, a low side wall 29 is left between the side walls 30. The side wall 29 provides mechanical stiffening of the patch tray 10 to minimise flexing.

The apertures 31 are arranged in a cross-configuration with the apertures oriented at±45°to the antenna axis. This causes the patches to emit and receive radiation with the orientation of the dominant components of the electric fields being at ±45° to the antenna axis.

Four printed circuit boards (PCB's) 40 are mounted on the rear of the patch tray 10. Four shields 50 are mounted to the underside of PCB's 40. The shields direct radiation from apertures 31 towards the patch assemblies.

A phase shifter support 60 is mounted to a back tray 70 by clamp members 71. A phase shifter assembly 61 is mounted to the rear of the phase shifter support 60.

Isolating assemblies are positioned between each patch assembly, each isolating assembly comprising a transverse strip 20 and an axial strip 21. The isolating assemblies are mounted by insulating studs 33, 34 shown in detail in FIG. 4. The studs are omitted from FIGS. 1-3 for clarity. The axial strips 21 have downwardly bent arms 22, which are mounted on walls 16 by insulating studs 33, which pass through apertures in the arms 22 and walls 16. The transverse strips 20 have arms 23 (shown in the plan view of FIG. 3) which are mounted to the base 14 of the double wall assembly 13. An additional insulating stud 34 mounts the longitudinal strip 21 on the transverse strip 23. The stud 34 passes through apertures in the strips 21,23. The isolating assemblies improve the isolation between the +45° and the −45° antenna ports.

The angle between the inner faces of transverse walls 12 and 16, and the base of tray 10, is approximately 56°. The angle between the side walls 30, and the base of tray 10, is approximately 58°. The upper edges 26 of transverse walls 16 are higher above ground plane 10 than the upper edges 28 of side walls 30.

It can be seen from the plan view of FIG. 3 that the distal edges 25,28 of the walls form a rectangular inner border around the patch assembly. The bases of the walls (where the walls join the ground plane) form a rectangular outer border. The area within the inner border is smaller than the area within the outer border. By reducing the area within the inner border (for instance by changing the angle or size of the walls) and increasing the size of the aperture 5, the 3 dB beam width can be increased, possibly up to 120°.

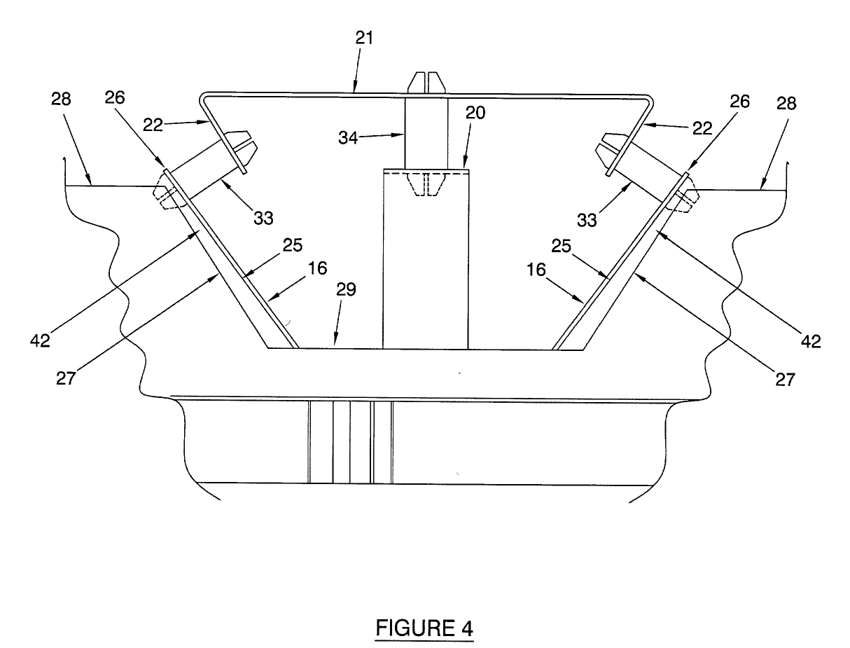

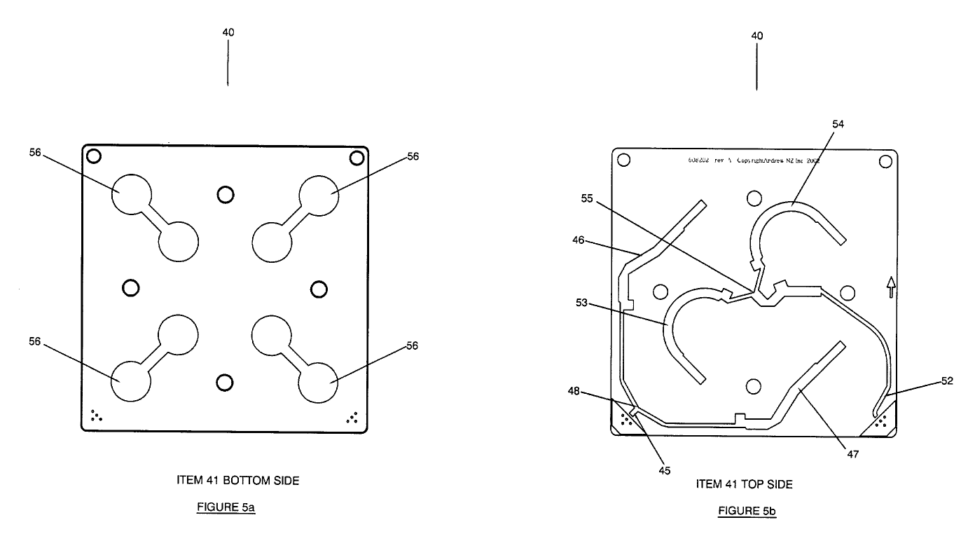

A PCB 40 is shown in detail in FIGS. 5a and 5b. FIG. 5b shows the lower side of the PCB (that is, the side opposite to the patches) and FIG. 5a shows the upper side of the PCB (that is, the same side as the patches). The PCB comprises a Taconic® substrate with copper layers on both faces. The copper on the lower face is etched away to leave the microstrip feedline network shown in FIG. 5b. Feedline 45 is coupled to feedlines 46,47 via junction 48. Feedline 52 is coupled to feedlines 53,54 via junction 55. The copper on the upper face is etched away in four regions to form “dumb-bell” shaped slots 56 shown in FIG. 5a. The upper face carries a thin layer of adhesive dielectric, which adheres the PCB 40 to the base of the patch tray 10, providing a capacitive connection between the copper on the upper face of the PCB, and the aluminium patch tray 10. The slots 56 are positioned in line with the apertures 31 in the base of the patch tray 10. The feedlines 46,47,53,54 pass across the central stem portion of the “dumb-bell” shaped slots 56. Thus the feedlines couple energy into slots 56, which in turn couple the energy into apertures 31, which in turn couple the energy to the upper and lower patches 2,3. The slots 56 (and thus the patches 2,3) radiate energy in two polarisations at 45 degrees to the antenna axis.

All parts of the antenna are formed from aluminium except for the PCB.

The off-cuts between the side walls 30 improve the isolation. In particular, the off-cuts enable energy to radiate outwardly, thus preventing radiation from one set of apertures 31 from coupling with a neighbouring patch assembly. The off-cuts also enable the U-shaped assemblies 13 to be inserted easily.

The walls 16 between the patch assemblies improve the isolation.

It will be noted that the patches 2,3 have sides, which lie parallel with the side walls 30. This provides two advantages in comparison with conventional antennas in which the square patches are oriented with their diagonals aligned with the antenna axis (see for instance WO02/50953). Firstly, the antenna has a greater beamwidth because the dimension of the radiating element in the horizontal plane (perpendicular to the antenna axis) is lower. Secondly, the relatively constant gap between the sides of the patches and the side walls results in improved repeatability of the electrical performance of the antenna.

The antenna is designed to operate in the 800 to 960 MHz frequency band, although it could be designed to work in other frequency bands. Isolation between polarisations is more than 30 dB for electrical downtilt angles from 1° to 10°. The height of the antenna above the base of the patch tray 10 is 60 mm. This is a lower profile than for any other existing radiator with a 90° 3 dB beamwidth.

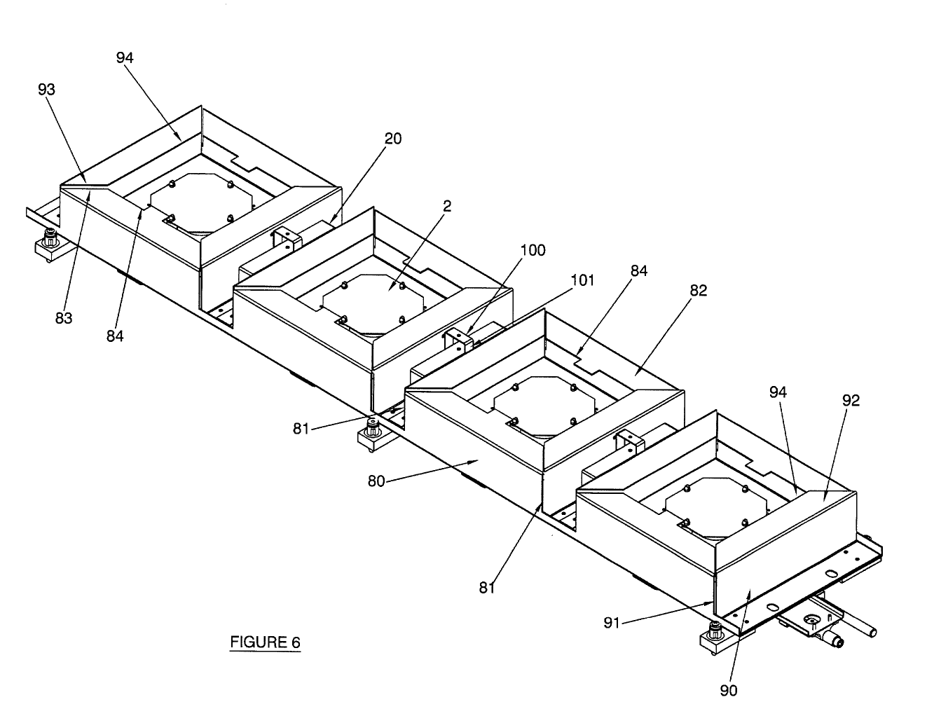

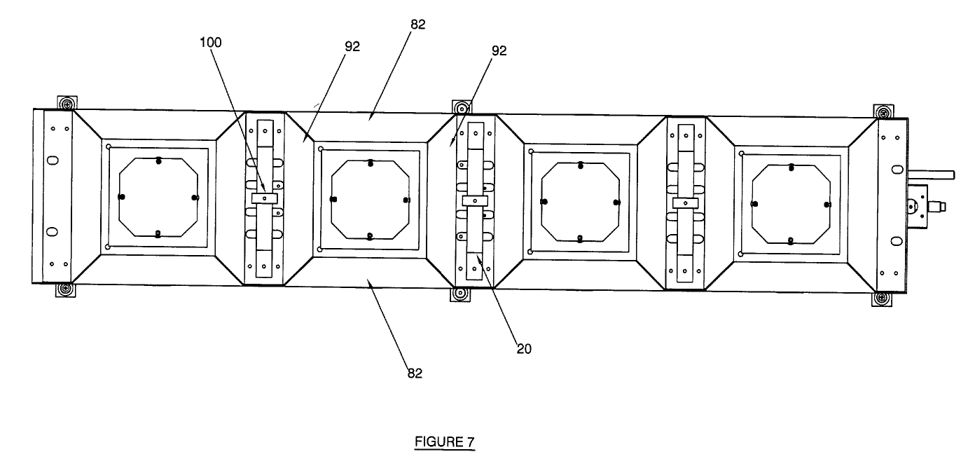

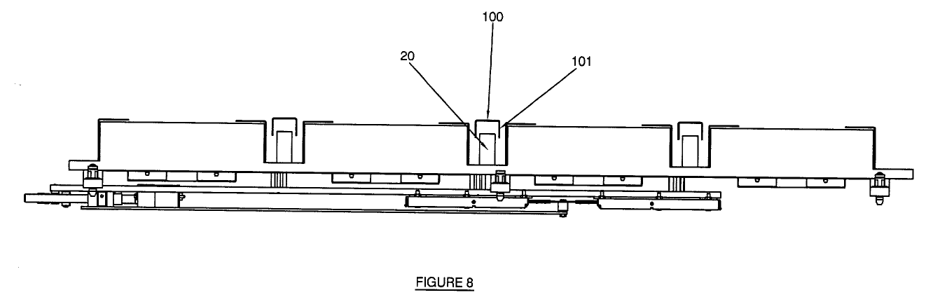

FIGS. 6 to 8 show an alternative antenna. Reference numerals are repeated for identical elements shown in FIGS. 1 to 4. The side walls have upright proximal portions 80 folded at right angles to the ground plane with parallel side edges 81. The side walls also have distal portions 82 folded parallel to the ground plane, with side edges 83, which taper toward distal edges 84. The transverse walls are similar in construction, with upright proximal portions 90 folded at right angles to the ground plane with parallel side edges 91, and distal portions 92 folded parallel to the ground plane with side edges 93 which taper toward distal edges 94. A small parallel-sided air gap is left between edges 81,91 and edges 83,93.

The walls of FIGS. 6 to 8 are easier to construct than the angled walls of FIGS. 1 to 6. However a disadvantage is that more material is required for a given beamwidth.

The axial strips 21 of FIGS. 1 to 6 are replaced by axial strips 100 with downwardly bent arms 101. The arms 101 are mounted on proximal portions 90 of the transverse walls by insulating studs (not shown), which pass through apertures in the arms 101 and wall portion 90.

In an alternative embodiment (not shown) the arms 101 may be omitted and the axial strips 100 mounted on the distal wall portions 92.

The drawings refer to an antenna with 4 radiating elements. However, any number of elements may be used, for instance 8.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A dual polarised antenna including two or more modules arranged along an antenna axis, each module including a radiating element, and four conductive walls which together form a frame around the radiating element, each wall including a distal edge and a pair of side edges, wherein the side edges of the walls meet, but do not touch, at respective comers of the frame.

2. An antenna according to claim 1 wherein at least part of the pair of side edges of each wall taper inwardly towards a respective distal edge.

3. An antenna according to claim 1 wherein the walls each have a proximal base which together form an outer border, wherein the distal edges of the walls together form an inner border, and wherein the area within the inner border is smaller than the area within the outer border.

4. An antenna according to claim 1 wherein each wall has a proximal portion, and a distal portion at an angle to the proximal portion.

5. An antenna according to claim 1 including a ground plane, wherein at least part of each wall subtends an acute angle with the ground plane.

6. An antenna according to claim 1 wherein the side edges of the walls are separated at the corners of the frame by respective air gaps.

7. A dual polarised antenna according to claim 1, wherein the antenna has a 3 dB beam width greater than 70 degrees.

8. A dual polarised antenna according to claim 1, wherein the antenna has a 3 dB beam width greater than 85 degrees.

9. A dual polarised antenna according to claim 1, wherein the antenna has a 3 dB beam width greater than 110 degrees.

10. A dual polarised antenna according to claim 1, wherein the radiating element is a patch element.

11. A dual polarised antenna according to claim 10, wherein the patch element has an aperture formed in a central region of the patch element.

12. A dual polarised antenna according to claim 1, wherein the radiating element is a patch element having four edges, and wherein each conductive wall runs substantially parallel with a respective edge of the patch element.

13. A dual polarised antenna according to claim 1 including a ground plane, wherein the ground plane and two of the conductive walls are formed from a single sheet of conductive material.

14. A dual polarised antenna according to claim 1 wherein the four walls around each element include a pair of side walls running parallel with the antenna axis, and a pair of walls running transverse to the antenna axis.

15. A dual polarised antenna according to claim 14 including a ground plane, wherein the distal edges of the side walls are closer to the ground plane than the distal edges of the transverse walls.

16. A dual polarised antenna according to claim 1 wherein an opposite pair of the walls each have a respective projection extending from its distal edge, each projection being positioned opposite to a centre of a respective radiating element.

17. An antenna according to claim 16 wherein each projection is substantially rectangular as viewed from a side of the antenna axis.

18. An antenna according to claim 17 wherein a stiffening wall running substantially parallel with the antenna axis is provided between each module.

19. A dual polarised antenna including two or more radiating elements arranged along an antenna axis; a plurality of conductive side walls running substantially parallel with the antenna axis; and one or more conductive wall assemblies, each wall assembly being arranged between a pair of radiating elements, wherein the or each wall assembly is substantially U-shaped as viewed in a cross-section taken along the antenna axis.

20. An antenna according to claim 19 wherein the or each wall assembly includes a base and a pair of walls, each wall having subtending an obtuse angle with the base.

21. An antenna according to claim 19 wherein the or each wall assembly is substantially symmetrical about a plane transverse to the antenna axis.

22. A dual polarised antenna according to claim 19 including a ground plane, wherein the distal edges of the side walls are closer to the ground plane than the distal edges of the transverse walls.

23. A dual polarised patch antenna including two or more radiating patch elements arranged along an antenna axis, each radiating patch element having first and second opposite side edges which run substantially parallel with the antenna axis; a plurality of conductive side walls running substantially parallel with the antenna axis; and one or more conductive isolating elements, each isolating element being arranged between a pair of radiating patch elements.

24. An antenna according to claim 23 wherein the or each isolating element includes a conductive wall running substantially transverse to the antenna axis.

25. A dual polarised antenna including two or more radiating patch elements arranged along an antenna axis; one or more axial isolating elements, each axial isolating element being arranged between a pair of radiating patch elements and including an elongate conductive member arranged with its length substantially parallel with the antenna axis; and one or more transverse isolating elements, each transverse isolating element being arranged between a pair of radiating patch elements and including an elongate conductive member arranged with its length substantially transverse with the antenna axis, wherein the axial and transverse isolating elements do not touch each other.

26. An antenna according to claim 25 wherein the axial isolating elements and the transverse isolating elements are strips which are substantially rectangular as viewed in a cross-section taken transverse to the length of the strip.

27. An antenna according to claim 25 including an insulating spacer between the axial and transverse isolating elements.

28. An antenna according to claim 25 including two or more conducting walls running substantially transverse to the antenna axis, each wall being arranged between a radiating element and an axial isolating element.

29. An antenna according to claim 28 wherein each axial isolating element is supported at each end by one of said transverse conducting walls.

30. An antenna according to claim 29 wherein each axial isolating element is coupled at each end to one of said conducting walls by an insulating spacer.

31. A dual polarised antenna including two or more radiating element arranged along an antenna axis; and a plurality of planar conductive side walls running substantially parallel with the antenna axis, wherein each side wall has a projection extending from an upper edge of the side wall, each projection being positioned opposite to a centre of a respective radiating element, and wherein each projection lies in the plane of its respective side wall.

32. An antenna according to claim 31 wherein each projection is substantially rectangular as viewed from a side of the antenna axis.

33. A dual polarised antenna including a radiating element; a ground plane; and a pair of conductive walls arranged on opposite sides of the radiating element, each wall subtending an acute angle with the ground plane, wherein the ground plane and conductive walls are formed from a single sheet of conductive material.
